(19) United States
(12) Patent Application Publication
(10) Pub. No.: US 2011/0314070 A1
(43) Pub. Date: Dec. 22, 2011

(54) OPTIMIZATION OF STORAGE AND TRANSMISSION OF DATA

(75) Inventors: Eileen C. Brown, Seattle, WA (US); Thomas E. Jolly, Redmond, WA (US); Joerg-Thomas Pfenning, Redmond, WA (US)

(73) Assignee: Microsoft Corporation, Redmond, WA (US)

(21) Appl. No.: 12/818,515

(22) Filed: Jun. 18, 2010

(51) Int. Cl. G06F 17/30

(52) U.S. Cl. 707/827; 707/E17.01

(57) ABSTRACT

The present invention extends to methods, systems, and computer program products for end-to-end optimization of data storage and transmission of data. Details of how data is stored within a data store are exposed to clients and applications. Clients and applications are enabled to makes requests to data stores to obtain data as it is actually stored upon within the data store to eliminate redundant processing of the requested data. Compression and de-duplication of data within a data store are leveraged to increase the efficiency and reduce latency of data transmitted over a LAN or WAN.

### CROSS-REFERENCE TO RELATED APPLICATIONS

N/A

### BACKGROUND

Storage optimization functionality is becoming increasingly important in order to be competitive in the file server and data storage market. Network traffic optimization is also important in computer and network environments and appliances that integrate into existing network infrastructure and performing real-time optimization of network traffic can provide useful benefits.

The amount of data being generated, transmitted, and stored on computers continues to grow at a rapid pace. Customers and competitors are driving an increasing trend towards the use of data optimization techniques in order to reduce storage requirements for data at rest. For example, data may be compressed and redundancies within stored data may be reduced in order to reduce the space required to store data. Similar techniques are also being applied to reduce the amount data which is transferred over networks, thus reducing LAN and WAN bandwidth costs and lowering application latencies. However, current solutions for data storage and data transmission are largely separate and distinct and no unified solutions are known. Because storage and transmission techniques are separate, there are redundancies, incompatibilities, and unnecessary overhead when data storage and data transmission are viewed together.

As an example, a file which is stored on a server (i.e., a data store) may be both compressed and stored in separate segments (e.g., chunks) when stored on a data storage server. When a client requests the file be transmitted to the client from the server, the server must reassemble the chunks and decompress the file to reconstitute the file before transmitting the file to the client.

Similarly, in order to reduce transmission bandwidth (e.g., over a network), latency, or transmission costs, a network agent may then take the file and compress it again before transmitting, transmit the compressed file to another endpoint, and then de-compress it at the other end of the transmission path.

What may be useful are unified data optimization tools and techniques encompassing storage, transmission protocols, file system APIs, data stores, servers, clients, applications, and cloud. Such tools and techniques could extend and enhance existing piece-meal and separate data storage and data transmission solutions by delivering optimized storage for data at rest that can be leveraged by data transfer and transmission protocols.

### BRIEF SUMMARY

The present invention extends to methods, systems, devices, and computer program products for end-to-end optimization of the storage and transmission of data. For example, embodiments described herein provide for leveraging and increasing efficiencies and optimizations for both data storage and transmission of data.

One example embodiment provides for a method for exposing the details of storage optimization within a data storage server to a client. The method includes accessing metadata describing the storage of file data upon the data storage server, wherein the file data is stored on the data storage server in a form distinct from a native form of the file data. The metadata exposes the storage form of the file data as stored on the data storage server.

A client can send a request for file data to a storage server and the client may receive from the data storage server information comprising file data, additional metadata describing the storage of file data upon the data storage server, and/or data representing at least a portion of the file data.

Another example embodiment provides for exposing the details of storage optimization within a data storage server to a client. This method includes sending metadata describing the storage of file data upon the data storage server. The file data is stored on the data storage server in a form distinct from a native form of the file data, and the metadata exposes the storage form of the file data as stored on the data storage server.

The data storage server receives a request for file data from a computing system and the data storage server sends information comprising file data, additional metadata describing the storage of file data upon the data storage server, and/or data representing at least a portion of the file data.

Another example embodiment provides for a computer program product for exposing the details of storage optimization within a data storage server to a client. The computer program product comprises computer-executable instructions for, inter alia, sending from a computing system a request for file data to the data storage server and receiving from the data storage server information comprising information describing the storage of the file data upon the data storage server.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of end-to-end optimization of storage and transmission of data.

FIG. 2 illustrates an example architecture for end-to-end optimization of storage and transmission of data.

FIG. 3 illustrates an example method for exposing details of storage optimization within a data storage server to a client, viewed from the client's perspective.

FIG. 4 illustrates an example method for exposing the details of storage optimization within a data storage server to a client, viewed from the server's persepective.

### DETAILED DESCRIPTION

The present invention extends to methods, systems, devices, and computer program products for end-to-end optimization of the storage and transmission of data. For example, embodiments described herein provide for leveraging efficiencies and optimizations for both the storage and transmission of data. The present invention extends to methods, systems, and computer program products for exposing the details of storage optimization within a data storage server to a client. The embodiments of the present invention may comprise a special purpose or general-purpose computer including various computer hardware or modules, as discussed in greater detail throughout.

One example embodiment provides for a method for exposing the details of storage optimization within a data storage server to a client. The method includes accessing metadata describing the storage of file data upon the data storage server, wherein the file data is stored on the data storage server in a form distinct from a native form of the file data. The metadata exposes the storage form of the file data as stored on the data storage server.

A client can send a request for file data to a storage server and the client may receive from the data storage server information comprising file data, additional metadata describing the storage of file data upon the data storage server, and/or data representing at least a portion of the file data.

Another example embodiment provides for exposing the details of storage optimization within a data storage server to a client. This method includes sending metadata describing the storage of file data upon the data storage server. The file data is stored on the data storage server in a form distinct from a native form of the file data, and the metadata exposes the storage form of the file data as stored on the data storage server.

The data storage server receives a request for file data from a computing system and the data storage server sends information comprising file data, additional metadata describing the storage of file data upon the data storage server, and/or data representing at least a portion of the file data.

Another example embodiment provides for a computer program product for exposing the details of storage optimization within a data storage server to a client. The computer program product comprises computer-executable instructions for, inter alia, sending from a computing system a request for file data to the data storage server and receiving from the data storage server information comprising information describing the storage of the file data upon the data storage server.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions may be physical storage media. Computer-readable media that carry computer-executable instructions may be transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

Computer program products may comprise one or more computer-readable storage media having encoded thereon computer-executable instructions which, when executed upon one or more computer processors, perform the methods, steps, and acts as described herein.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

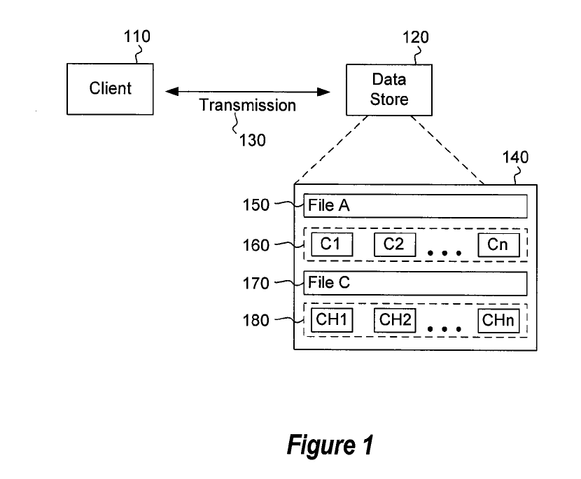

FIG. 1 illustrates an example environment in which the present invention may operate. FIG. 1 depicts a client 110, a data store 120, and data transmission 130 between the client 110 and data store 120. Data may be stored upon the data store 120 in many different forms.

Embodiments presented herein describe methods, systems, and computer program products to integrate and optimize the storage 140 and transmission 130 of data in environments such as that illustrated by FIG. 1.

A file may be stored within a data store in its native form, as a contiguous file. For example, fileA 150 is stored within the data store 120 in an unaltered raw or native format comprising all the bits, bytes, and data of the file as may be presented by or expected by an application. Data may also be stored in a variety of alternate formats. For instance, data may be stored in a compressed format to reduce necessary storage space and data may be stored using techniques to reduce redundancy and de-duplicate the data stored upon a data store.

Data may be stored upon a data store in chunks or blocks in which a file is broken into separate and distinct subsets of data. For example, a file may be stored within a data store as chunks 160 C1 through Cn. Chunks, subsets of data from a file, may sometimes also be termed blocks and the two terms, chunks and blocks, are used interchangeably herein. (It may be noted that the term file, as used herein, describes any logically related group or amount of data.)

A data store may have an algorithm for breaking a file into chunks in order to optimize the storage of data. For example, a file may be broken into chunks 160 C1 through Cn in order to store the file within the data store in a more efficient or compact manner. A file broken into chunks may also be stored more efficiently by reducing redundancy within the file. For instance, chunk C1 may occur within a file more than one time. By breaking the file into chunks, chunk C1 need only be written to the data store once and each repetitive occurrence of chunk C1 within the file could then be replace by a reference or pointer to the chunk C1.

As may be appreciated, chunks or blocks are not necessary any fixed length and may be any length, any amount of data, or any portion of a file, including an entire file. Chunks or blocks of a file may be arbitrary lengths and/or offsets within a file. Partitioning of a file into chunks or blocks may follow any algorithm or technique and the size of the chunks may be influenced or dictated by the particular considerations of a data store upon which data is to be persisted or upon a transmission path over which data is to be transmitted.

Data may also be stored within a data store in a compressed format. For example, fileC 170 is stored in a compressed format in which an original file was compressed using a compression algorithm to create a file, fileC 170, which occupies less storage space within the data store than the original, uncompressed file data. Compression of files and data may be performed by techniques well-known in the industry such as Lempel-Ziv (LZ), Lempel-Ziv-Welch (LZW), and MPEG compression.

A combination of compression and chunking (or blocking) may also be employed on a data store. For example, a file may be broken into chunks which are then compressed and stored as compressed chunks 180 CH1 through CHn.

Another optimization may be gained by de-duplicating files and data stored within a data store. De-duplication identifies identical files or identical portions of data which may occur within distinct files which are stored within a data store and replaces all but one of the duplicated files or data portions by a reference to a reference copy of the file or portion of data. By de-duplicating files, only one copy of a particular file or portion of data would be stored in a data store thereby saving the storage space which would have been occupied by the multiple, duplicate files or data portions.

De-duplication may also be performed on a file chunk level. For example, if two or more files were chunked into data chunks, then duplicate chunks may be replaced in the data store with references to a copy of the redundant chunks. For example, a file may be stored on data store 120 as chunk C1 and a references to other chunks already stored in association with other files stored in chunk format within data store 120. For example, fileX may be stored as references to chunks C1 through Cn; fileY could be stored as references to chunks CH1, C1, and C2; and fileZ could be stored as a list of references to chunk C1 and compressed chunks CH2 through CHn.

De-duplication, chunking, and compression of file data may also be performed in combination. For example, a file may be stored on a data store as one or more chunks where each of the chunks has been compressed. File data may also be stored in any combination where some files are stored uncompressed, some files are stored compressed, some files are stored in a chunked format, and some files are stored as chunks whereby some chunks are compressed and some chunks are not compressed.

Generally, when a client requests data from a data store, the client would ask for data for an entire file or for some logical portion of the file. For example, a client may request get (fileX) through a file system or may request through a file system getFileBytes (fileX; bytes=100-1000). When the file or portion of the file is transmitted 130 from the data store 120 to the client 110, the burden falls upon the data store to uncompress the compressed data or reassemble the chunks of data in order to reassemble and transmit to the client the requested data in the format expected by the client or application.

Embodiments described herein allow a client to request or access information concerning the storage of file data upon the data store so that efficiencies and optimizations may be gained by providing the client with information concerning the storage details of the data stored upon the data store. For example, a client 110 may request the data store 120 inform the client how fileX is stored on the data store. The data store may inform the client that fileX is stored as compressed chunks CH1 and CH3. As it would be more efficient to transmit the compressed chunks to the client in the compressed form, the client may then request the data store transmit the chunks CH1 and CH3 to the client instead of requesting get (fileX) which would necessitate the data store to decompress chunks CH1 and CH3 and reassemble the file before transmitting the file to the client.

Embodiments also allow a client to access information concerning the storage of file data upon the data store so that efficiencies and optimizations may be gained by providing the client with information concerning the storage details of the data stored upon the data store. For example, a client 110 may access locally cached or stored information identifying how fileX is stored on the data store. This information may have been acquired by previous requests or may have been cached over the course of previous transactions between a client and a data store.

Additional efficiencies may be gained if the client already has a copy of chunk CH1 stored locally or available from a storage location with lower latency or transmission costs than data store 120. In such a case, the client may then request from the data store only getChunk (CH3).

Embodiments described herein reduce redundant LAN and/or WAN traffic between clients and data stores and/or centralized servers. Embodiments herein enable storage and transmission optimization for various network file system protocols. For instance, both the SMB and HTTP protocols may be extended enhanced by the devices and techniques described.

Standard file system protocols (e.g., SMB and HTTP) can be extended to provide an API which enables a client to request data from a data store which, when provided by the data store, exposes the details of how a file or data portion is stored upon the data store. For example, client 110 may request data from data store 120 as to how fileX is stored upon data store 120. For example, client 110 may call a file system extension such as getStorageDetails (fileX) and the data store may respond with {fileX:=chunks CH1, CH3}. Now having knowledge of the details of how fileX is stored upon the data store, the client may then decide how to request data associated with fileX from the data store. The client could, in standard fashion, request the entire file in its raw or native format. Embodiments herein enable, in contrast, the client to request the data store transmit the compressed chunk CH3 to the client.

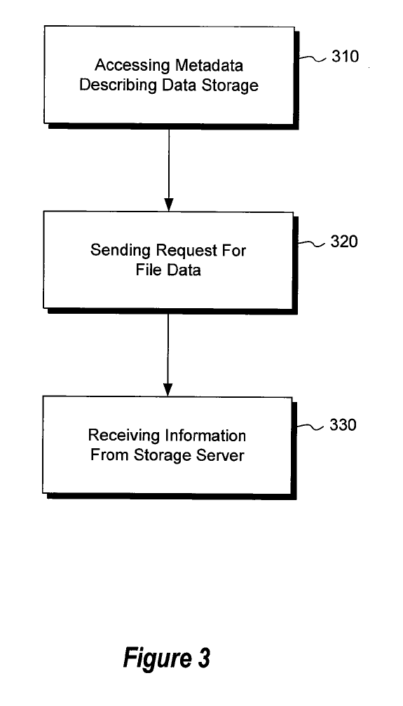

In one embodiment, as in FIG. 3, a client may access 310 metadata describing the storage of file data upon a data storage server, wherein the file data is stored on the data storage server in a form distinct from a native form of the file data, and wherein the metadata exposes the storage form of the file data as stored on the data storage server. The metadata describing the storage of file data upon a data storage server may be information describing how the file data was chunked on the data store, how the file data was compressed on the data store, or how the file data is both chunked and compressed on the data store.

The details of how a file is chunked may include which portions of a file correspond to each chunk stored upon a server. The details of chunking may also include a cryptographic hash of each of the chunks which make up a file. The cryptographic hashes of the chunks enable clients, applications, and data stores to uniquely identify each chunk. Using this information, a client, application, or other data store may be able to identify if it already has available an identical chunk as identified by its cryptographic hash.

Details of how a file or portion of data (e.g., chunk) is compressed may include a cryptographic hash of the original uncompressed data to uniquely identify the data. It may also include a cryptographic hash of the compressed data to uniquely identify the compressed data. The details may also include the type of compression used to perform the compression (which may be necessary in order to decompress the compressed data after transmitting it to another endpoint from the data store). Types of compression may include, for example, LZ, LZW, MPEG, and the like.

By accessing the metadata, the client may become aware of the storage details of the data stored on the data store. When the client is aware of the details of the storage of the data on the data store, the client may send 320 a request for file data to the storage server. By employing embodiments described herein, the client need not request an entire file, the client may request only those chunks of a file it may need or may request a compressed version of a file or a compressed version of a chunk of a file. After having sent 320 the request for file data, the client may receive 330 information from the storage server comprising the requested file data, additional metadata describing the storage of file data upon the storage server, and/or data representing at least a portion of the file data.

Receiving 330 of file data information may include at least one of file data, additional metadata describing the storage of file data upon the data storage server, and/or data representing at least a portion of the file data. The information may comprise file data in a standard format as a legacy application at a client may expect it. The information may comprise information describing the storage of file data upon a data store. The information may comprise data which represents at least a portion of the file data.

Accessing 310 metadata describing the storage of file data may comprise sending a request to a server for information describing the storage of the file data. Such a request may be in the form of a file system extension which enables the client the make a call to the file system (or network file system) to request the details of how a file, file data, or portion of data is stored upon a data store.

Accessing 310 metadata describing the storage of file data may, alternatively, comprise accessing a local store for information describing the storage of the file data. The information in the local store may have been received previously from the file server in response to a previous request or may have been cached locally as part of an ongoing series of file system transactions. Accessing 310 metadata describing the storage of file data may comprise a file system call (introduced by extension of normal file system APIs) which returns details that expose the storage form of the file data as stored upon a data storage server or how locally cached copies are stored locally to the client.

For example, the metadata describing the storage of file data upon the data storage server may comprise data describing the storage of the file data resulting from de-duplication of the file data upon the data storage server. The metadata may comprise a chunk list of chunks making up a file and may comprise a hash list of cryptographic hashes of each of the chunks making up a file. The client may then use the returned chunk list or the hash list to formulate a request for one or more of the chunks to be transmitted or may use the hash list to compare to a list of chunks already received or locally cached to determine if any chunks need to be requested from the data store.

For example, when downloading a file, a client may request a hash list from a file server and also query peer clients and/or query peer file servers for desired data. The client may receive 330 information comprising a hash list as a response to the query. The hash list may represent the data as it is stored on the data store and a client may be enabled to request only the portions of data (e.g., chunks) which it needs. Data may also be read from a peer when the peer has the desired data and the transmission costs or latency for data transmission between the peer and the client are lower than the transmission costs or latency between the client and the data store.

The metadata describing the storage of file data upon the data storage server may also comprise data describing a compressed subset of the file data or data describing a compressed version of the file data. Using this information, a client may formulate a request for the compressed subset of the file data or formulate a request for the compressed version of the file data. This would provide the efficiency of the data store not needing to de-compress the file data or subset of file data before transmitting the data in response to the request for the file data.

In one embodiment, a client may send 320 a request for file data which may comprise a request for an entire file or a request for a portion of a file. For example, a request for a file, get (fileX), or a request for a portion of a file, getFileBytes (fileX; bytes=100-1000), may be sent through a file system to a data storage server. In response, the data storage server may respond by sending not the file or the portion of the file, but data in a possibly different form which contains the requested file or portion of the file.

For example, the data storage server could return file data comprising a range of compressed chunks that fully cover the requested file or the requested portion of the file. Additionally, the data storage server could return file storage metadata along with the chunks which identify that the returned chunks comprise the requested data (and possibly more data than requested).

Additionally, if the chunks returned were compressed, the data storage server may return file storage metadata which identifies that the data (or chunks of data) returned were compressed and may identify which compression technique or algorithm was used to compress the data or which decompression technique or algorithm needs to be used to decompress the data. As may be appreciated, there may be a default compression or decompression technique which may be assumed in the case that compressed data and/or compressed chunks are returned without also returning metadata identifying a particular compression or decompression technique.

The client may then receive 330 this data and/or metadata from the data storage server and perform the appropriate decompression and/or chunk assembly on the client side in order to reconstruct the requested data. As may be appreciated, this may be more efficient due to data transmission costs or transmission latency than to have the data storage server decompress and/or assemble the particular data actually requested by the client prior to transmission to the client and/or receipt by the client.

The file storage metadata may comprise a cryptographic hash list of chunks or compressed chunks and an identifications as to which chunks comprise which portions of file data. By using the cryptographic hash list of chunks or compressed chunks and an identifications as to which chunks comprise which portions of file data, a client may be able to appropriately decompress compressed data and/or reassemble chunks which contain all or more of a range of data desired by or requested by a client.

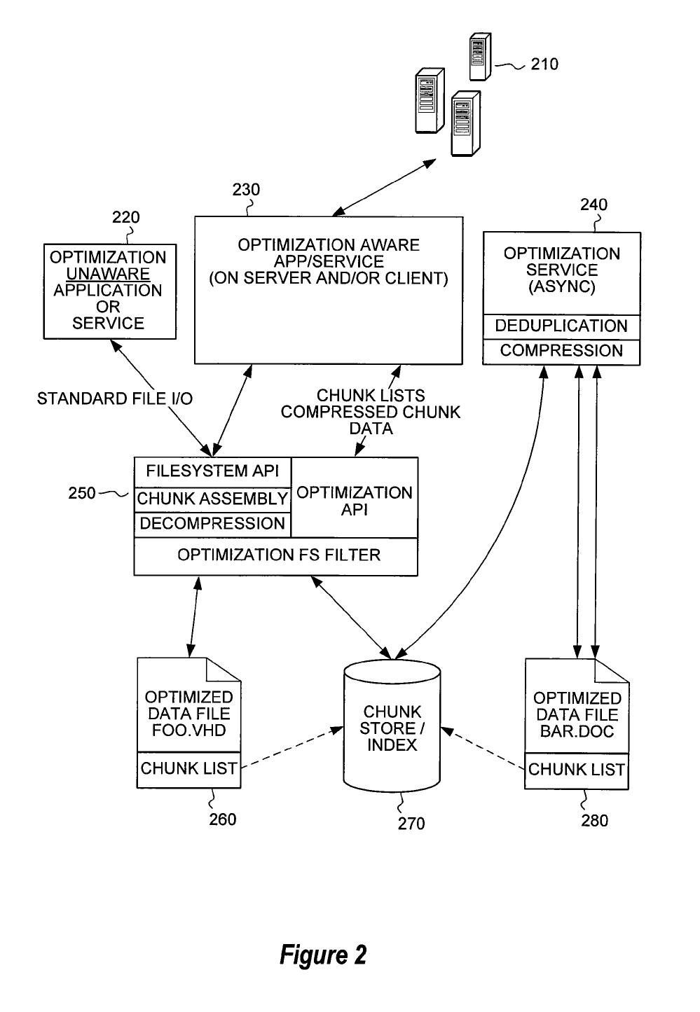

An example architecture for an integrated approach to file storage and transmission is illustrated by FIG. 2. Clients and servers 210 may comprise optimization aware applications and or services. The clients and servers may communicate with a file system interface 250 which may comprise a file system application programming interface (API) and may also comprise an optimization API. The file system API may comprise all the normal calls and functions of a normal file system and/or network file system. The optimization API comprises extended API elements (e.g., function calls and interfaces) which expose the storage details of data 260, 270, and 280, which is stored upon a data store.

The file system interface 250 enables a client to request metadata describing the storage of file data upon a data storage server. The file system interface 250 also enables a client to request data from a data storage server in a number of formats. The client may request data using the normal file system API (e.g., a standard or legacy file system API) to get a file intact in its raw or native format. The client may also request data using the optimization API in order to request only a particular chunk of a file, a compressed form of a file as stored on a server, and may request a compressed chunk of a file as stored upon the server.

Clients, applications, and services 220 which are unaware of the enhanced and/or extended file system interface 250 may still operate normally, unchanged and unhindered by making calls to the file system API which preserves all the functionality of a legacy file system API.

Clients, applications, and services which are optimization aware 230 may make calls to the optimization API to invoke the full functionality of the embodiments described herein. Optimization aware clients, applications, and services may request hash lists, chunk lists, compressed data, etc., from a data store or server. For instance, file foo.vhd may 260 may be stored on a data store as a chunk list which points to a chunk store/index 270. The chunk store/index may include chunks (e.g., chunks 160 C1-Cn), may include compressed chunks (e.g., chunks 180 CH1-CHn), and may include references, pointers and indexes to the stored chunks which enable de-duplication and other optimization of file and data storage.

A client may request through the optimization API metadata describing the storage of foo.vhd and receive metadata from the data store which describes how foo.vhd is stored. Once the client has accessed the metadata, it may send a request through the optimization API for file data to the storage server. The request may be for the entire file in its native format or the request may be for only one or more chunks or compressed chunks of the file as stored in the chunk store/index 270.

The client may then receive from the data storage server information comprising one or more of file data, additional metadata describing the storage of file data upon the data storage server, and data representing at least a portion of the file data. The client may receive an entire file in its native format. The client may receive the entire file as compressed within the data store. The client may receive a chunk of the file. The client may receive a compressed chunk of a file. The client may receive additional metadata describing the storage of the file data, and may receive data comprising a portion of the file data. The response received by the client may correspond to the request made through the extended optimization API which enables clients and applications to make requests which are aware of the details of the storage of data within the data store.

In another example, file bar.doc may have been compressed, chunked, and de-duplicated by an optimization service 240 and stored as pointers into the chunk store/index 270. In an embodiment herein, a client may request metadata describing the storage of bar.doc upon a data store and, after receiving the information describing the storage of bar.doc upon a data store send a request for one or more of the compressed chunks of bar.doc which are stored in the chunk store/index 270. As the compressed chunks were requested by the client, the data store needs not decompress the chunks of bar.doc nor does the data store need to reassemble the chunks of bar.doc in order to respond to a request from the client for bar.doc.

In another embodiment, a method is provided for exposing the details of storage optimization within a data storage server to a client. This method includes sending metadata describing the storage of file data upon the data storage server, wherein the file data is stored on the data storage server in a form distinct from a native form of the file data, and wherein the metadata exposes the storage form of the file data as stored on the data storage server. The method also includes receiving at the data storage server a request for file data from a computing system. The method also includes sending from the data storage server information comprising at least one of file data, additional metadata describing the storage of file data upon the data storage server, and data representing at least a portion of the file data.

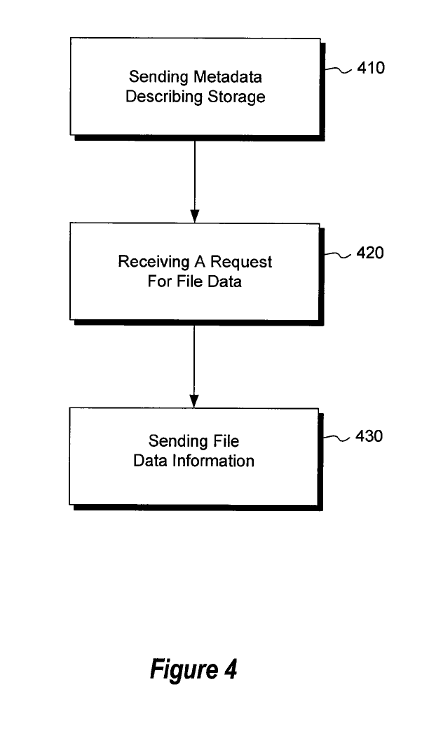

As illustrated in FIG. 4, a server or data store may send 410 metadata describing the storage of file data upon the data storage server or data store. The file data is stored upon the data storage server in a form distinct from a native form of the file data. For example, the file data may be stored upon the storage server in a chunked format, in a compressed format, or in a combination of compressed and chunked format.

The metadata which is sent provides information which exposes the storage form of the file data as it is stored upon the data storage server. For example, the metadata may include information which exposes that the file data is stored in a chunked, a compressed, or a combination of chunked and compressed formats. The metadata may comprise information which includes a hash list of chunks which make up the file data as stored upon the data store. The chunks stored upon the data store may the chunks which have resulted from a de-duplication of the file data (as well as other file data) stored upon the storage server.

The metadata may comprise information including a cryptographic hash of a subset of the file data. A cryptographic hash of a subset of the data may be used by a client, by a transmission device, or by another data store to identify whether a chunk is identical to another chunk. By using the cryptographic hash of a subset of the file data, clients, transmission devices, and other data stores are enabled to determine if a particular subset of data is available locally or available from a source with lower latency or transmission costs. By identifying identical subsets of data, it may be determined if a particular subset of data needs to be requested or transmitted.

A subset of file data may be the entire file or file data. A subset of the data may also be one or more chunks of file data which has been chunked by the data store as part of a storage optimization or de-duplication regime.

The metadata describing the storage of file data upon the data storage server or data store may also include data describing that some or all of the file data is compressed on the data storage server or data store. The metadata may include information that one or more chunks of a chunked format of the file data have been compressed. By using the information indicative that some portion of file data is compressed, a client may request a file or one or more chunks of a file to be returned in a response to the client in the chunked or compressed format as stored within the data store. By requesting a particular chunk or compressed chunk of a file, overhead is reduced as the data store does not need to uncompress a file or chunk of a file before transmitting the file or chunk of a file to the requesting client.

FIG. 4 also depicts receiving 410 a request for file data from a computing system. The request may be received from a client, from another storage server, from an application executing on a remote computing system, or the like. The request may be formatted using a protocol corresponding to an optimization API which extends and/or enhances a standard network file system API.

The request for file data may include information identifying particular chunks of a file which are requested. The request may also include information identifying whether the file data requested should be sent in a compressed or uncompressed format. The request may include information that only a subset of the chunks of a file should be sent as the other chunks are already available locally.

FIG. 4 also depicts sending 430 file data information which includes at least one of file data, additional metadata describing the storage of file data upon the data storage server, and data representing at least a portion of the file data. The sending 430 of the file data information may be in response to the request received 420 for file data. As discussed above, the request for file data may be for file data as it is stored on the data store as chunks, in compressed format, or in any combination.

The sending 430 of the file data information may include at least one of file data, additional metadata describing the storage of file data upon the data storage server, and data representing at least a portion of the file data. The information may comprise file data in a standard format as a legacy application at a client may expect it. The information may comprise information describing the storage of file data upon a data store. The information may comprise data which represents at least a portion of the file data.

The received request may have identified particular chunks of data which are desired by a client. In response to this request, the data store may send the requested chunks of data to the requesting client. The received request may have identified particular compressed subsets of data which are desired by a client. In response to this request, the data store may send the requested compressed subsets of data of data to the requesting client. The received request may have identified particular cryptographic hashes identifying chunks of data which are desired by a client. In response to this request, the data store may send the particular chunks of data which are identified by the cryptographic hashes to the requesting client.

In one embodiment, a data store may receive 420 a request for a file or portion of a file. For example, a data store may receive request get (fileX) for a file or may receive a request getFileBytes (fileX; bytes=100-1000) for a portion of a file. The data store may construct a response to the request and send file data information which includes file data as stored on the data store and include metadata identifying the storage details of the file data as stored. For example, a data store may return a set of chunks and metadata identifying which chunks comprise which portions of the requested data. Additionally, the data store may return metadata comprising compression and/or decompression information which may be appropriate in order to decompress data which was returned in a compressed format.

In some embodiments, the request may be received 420 and the file data information may be sent 430 without performing a previous step of sending metadata 410. For example, an optimization aware client may simply request file data, the data store could receive the request 420, and the data store could compose a response and send the response to the client assuming that the client can appropriately handle the returned file data and/or metadata and appropriately reassemble chunks and/or decompress data as necessary.

Embodiments also provide for support of write path optimizations for storage and transmission of data. For example, a client with local modifications to a file may generate a hash list representation of the modified file. This hash list may then be transmitted to a data storage server. The data storage server may then compare the received hash list representing the modified file with a comprehensive hash list maintained on the data storage server which identified file chunks stored on the data storage server.

Based on this comparison, the data storage server may then return to the client a list of chunks it already has stored upon the data storage server. The data storage server may also return to the client a list of the chunks which are not stored on the data storage server. Based on the returned list of chunks stored (or the list of chunks not stored) on the data storage server, the client could then transmit to the data storage server those chunks which are not already stored on the data storage server.

Having received a hash list representing the modified file and having received the chunks of the modified file which were not already stored upon the data storage server, the data storage server may now store the complete modified file (which is comprised of some chunks already stored on the server, some chunks newly received by the server, and a hash list (or chunk list) representing the complete modified file). By transmitting a hash list (or chunk list) representing the complete file and transmitting only those chunks not already stored upon the data storage server, optimizations in the transmission of the data from the client to the data store may be realized.

For example, the data storage server may receive a hash list from a client and compare the transmitted hash list representing the file with a hash list stored in a chunk store/index 270 which comprises chunks stored on the data storage server and an index of cryptographic hashes for the chunks stored on the data storage server. The data store may then return to the client the hash list representing the chunks which are not already stored in the chunk store and index 270. The client may then transmit to the data store the chunks not already stored in the chunk store. The data store may then store the received chunks in the chunk store 270 along with the hash list representing the complete modified file. In this fashion, the data storage server may now store a complete representation of the modified file (in terms of a chunk list representing the file and the corresponding chunks), but without the need for the client to transmit all the chunks which make up the file.

In another example, a file comprised of five chunks, chunks C1-C5, may be modified by a client only in chunk C4 (resulting in modified chunk Cm4). The client may send a hash list representing chunks C1-C3, Cm4, and C5 to a data storage server. This hash list now represents the complete modified file. The data storage server may then respond to the client that is already has chunks C1-C3 and C5 stored upon the server, but is missing chunk Cm4. The client could then send chunk Cm4 to the data storage server. The data storage server may then store chunk Cm4 on the data storage server and, together with the received hash list representing chunks C1-C3, Cm4, and C5, and the already stored chunks C1-C3 and C5, now has the complete modified file stored upon the data store.

As may be appreciated, this write path embodiment is enabled in similar fashion for newly created files as well as for modified files. A client may create a chunk list for any file—whether modified file or a newly created file—and send the chunk list to the data storage server so that the data storage server can compare the received chunk list to a list of chunks already stored upon the server. Additionally, the chunk list may be a cryptographic hash list uniquely identifying each of the chunks which make up the file. The chunks, themselves, as discussed herein, may be compressed chunks, chunks in a raw data format, or even chunks which have been altered in some fashion, cryptographically or otherwise.

The chunks, when transmitted, may be transmitted in a raw data format, in a compressed format, or otherwise. As may be appreciated, when file data portions are transmitted in compressed format, it may result in the optimization that the transmission infrastructure does not need to compress the data to gain efficiencies in transmission and the data storage server does not need to compress the data to optimize the storage on the data storage server. By transmitting only those compressed chunks not already stored or present on the receiving end of the transmission, optimizations may be realized in both the transmission and the storage of the file data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method in a computing environment comprising a client and a data storage server, the method for exposing the details of storage optimization within the data storage server to the client, the method comprising:
accessing metadata describing the storage of file data upon the data storage server, wherein the file data is stored on the data storage server in a form distinct from a native form of the file data, and wherein the metadata exposes the storage form of the file data as stored on the data storage server;
sending from the client a request for file data to the data storage server; and
receiving from the data storage server information comprising one or more of file data, additional metadata describing the storage of file data upon the data storage server, and data representing at least a portion of the file data.

2. The method of claim 1 wherein the metadata describing the storage of file data upon the data storage server comprises data describing the storage of the file data resulting from de-duplication of the file data upon the data storage server.

3. The method of claim 1 wherein the metadata describing the storage of file data upon the data storage server comprises a cryptographic hash of a subset of the file data.

4. The method of claim 1 wherein the metadata describing the storage of file data upon the data storage server comprises a cryptographic hash of each of a plurality of subsets of the file data.

5. The method of claim 1 wherein the metadata describing the storage of file data upon the data storage server comprises data describing a compressed subset of the file data.

6. The method of claim 1 wherein the request for file data comprises metadata describing a subset of the file data.

7. The method of claim 1 wherein the request for file data comprises a cryptographic hash of a subset of the file data.

8. A method in a computing environment comprising a client and a data storage server, the method for exposing the details of storage optimization within the data storage server to the client, the method comprising:
sending metadata describing the storage of file data upon the data storage server, wherein the file data is stored on the data storage server in a form distinct from a native form of the file data, and wherein the metadata exposes the storage form of the file data as stored on the data storage server;
receiving at the data storage server a request for file data from a computing system; and
sending from the data storage server information comprising at least one of file data, additional metadata describing the storage of file data upon the data storage server, and data representing at least a portion of the file data.

9. The method of claim 8 wherein metadata describing the storage of file data upon the data storage server comprises data describing the storage of the file data resulting from de-duplication of the file data upon the data storage server.

10. The method of claim 8 wherein metadata describing the storage of file data upon the data storage server comprises a cryptographic hash of a subset of the file data.

11. The method of claim 8 wherein metadata describing the storage of file data upon the data storage server comprises a cryptographic hash of each of a plurality of subsets of the file data

12. The method of claim 8 wherein metadata describing the storage of file data upon the data storage server comprises data describing a compressed subset of the file data.

13. The method of claim 8 wherein the request for file data comprises information describing a subset of the file data.

14. The method of claim 8 wherein the request for file data comprises a cryptographic hash of a subset of the file data.

15. A computer program product comprising one or more computer-readable storage media having encoded thereon computer-executable instructions which, when executed upon one or more computer processors, performs a method for exposing the details of storage optimization within a data storage server to a client, the method comprising:
sending from a computing system a request for file data to the data storage server; and
receiving from the data storage server information comprising information describing the storage of the file data upon the data storage server.

16. The computer program product of claim 15 wherein the information comprising information describing the storage of the file data upon the data storage server comprises data describing the storage of the file data resulting from de-duplication of the file data upon the data storage server.

17. The computer program product of claim 15 wherein the information comprising information describing the storage of the file data upon the data storage server comprises a cryptographic hash of a subset of the file data.

18. The computer program product of claim 15 wherein the information comprising information describing the storage of the file data upon the data storage server comprises a cryptographic hash of each of a plurality of subsets of the file data

19. The computer program product of claim 15 wherein the information comprising information describing the storage of the file data upon the data storage server comprises data describing a compressed subset of the file data.

20. The computer program product of claim 15 wherein the request for file data comprises information describing a subset of the file data.
